(19) United States
(12) Patent Application Publication
(10) Pub. No.: US 2022/0268934 A1
(43) Pub. Date: Aug. 25, 2022

(54) GLOBAL ENVIRONMENT MODEL FOR PROCESSING RANGE SENSOR DATA

(71) Applicant: QUALCOMM Incorporated, San Diego, CA (US)

(72) Inventors: Urs NIESEN, Berkeley Heights, NJ (US); Jayakrishnan UNNIKRISHNAN, Bellevue, WA (US)

(21) Appl. No.: 17/669,001

(22) Filed: Feb. 10, 2022

Related U.S. Application Data
(60) Provisional application No. 63/151,922, filed on Feb. 22, 2021.

(51) Int. Cl. G01S 17/86; G01S 7/48; G01S 13/58; G01S 17/88

(52) U.S. Cl. CPC G01S 17/86; G01S 7/4808; G01S 13/588; G01S 17/88

(57) ABSTRACT

Disclosed are systems and techniques for processing range sensor data. For instance, an apparatus can be configured to obtain a plurality of measurements from one or more range sensors, and to determine, based on a sparsity constraint, a plurality of coefficients corresponding to a sparse basis expansion of a global environment model. In some aspects, the apparatus can be further configured to perform operations to determine, based on the global environment model, the plurality of coefficients, and the plurality of measurements, at least one of a linear velocity, an angular velocity, or both, corresponding to a range sensor of the one or more range sensors, wherein the global environment model is based on a sparse basis expansion.

### CROSS-REFERENCE TO RELATED APPLICATIONS

This application claims the benefit of U.S. Provisional Application No. 63/151,922, filed Feb. 22, 2021, which is hereby incorporated by reference in its entirety and for all purposes.

### FIELD OF THE DISCLOSURE

The present disclosure generally relates to processing range sensor data. For example, aspects of the present disclosure include systems and techniques for processing range sensor data using a global environment model.

### BACKGROUND OF THE DISCLOSURE

A range sensor can be used to determine a distance or proximity of a device (e.g., a device including the range sensor) to an object. Examples of range sensors can include light detection and ranging (LIDAR) sensors, laser range finders, radars, ultrasonic sensors, infrared (IR) sensors, among others. Range sensors can be used in a wide range of applications, which can include robotics, vehicular systems (e.g., smart cars, autonomous vehicles, etc.), navigation systems, aviation systems, among other applications.

Range sensors can collect data by outputting or emitting a signal (e.g., laser, infrared, light emitting diode (LED), ultrasonic waves, radio frequency (RF) signals, etc.) and measuring the characteristics of reflected signals that the range sensor receives. Examples of measurements include the time of flight, the angle of arrival, the intensity of reflected signals, among others. In some instances, a range sensor may be in motion (e.g., mounted on a mobile object such as a robot or vehicle) and the data from the range sensor can be used to determine velocity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for processing range sensor data. According to at least one example, a method is provided for processing range sensor data. The method can include: obtaining a plurality of measurements from one or more range sensors; determining, based on a sparsity constraint, a plurality of coefficients corresponding to a sparse basis expansion of a global environment model; and determining, based on the global environment model, the plurality of coefficients, and the plurality of measurements, at least one of a linear velocity and an angular velocity corresponding to a range sensor of the one or more range sensors.

In another example, an apparatus for processing range sensor data is provided that includes one or more range sensors, a memory, and at least one processor (e.g., configured in circuitry) coupled to the memory. The at least one processor is configured to: obtain a plurality of measurements from the one or more range sensors; obtain a plurality of measurements from a range sensor of the one or more range sensors; determine, based on a sparsity constraint, a plurality of coefficients corresponding to a sparse basis expansion of a global environment model; and determine, based on the global environment model, the plurality of coefficients, and the plurality of measurements, at least one of a linear velocity and an angular velocity corresponding to a range sensor of the one or more range sensors.

In another example, a non-transitory computer-readable medium is provided that includes stored thereon at least one instruction that, when executed by one or more processors, cause the one or more processors to: obtain a plurality of measurements from one or more range sensors; determine, based on a sparsity constraint, a plurality of coefficients corresponding to the sparse basis expansion of the global environment model; and determine, based on the global environment model, the plurality of coefficients, and the plurality of measurements, at least one of a linear velocity and an angular velocity corresponding to a range sensor of the one or more range sensors.

In another example, an apparatus for processing range sensor data is provided. The apparatus includes: means for obtaining a plurality of measurements from one or more range sensors; means for determining, based on a sparsity constraint, a plurality of coefficients corresponding to the sparse basis expansion of the global environment model; and means for determining, based on the global environment model, the plurality of coefficients, and the plurality of measurements, at least one of a linear velocity and an angular velocity corresponding to a range sensor of the one or more range sensors.

In some aspects, the apparatus is or is part of, and/or includes a vehicle or a computing device or component of a vehicle (e.g., an autonomous vehicle), a robotics device or system or a computing device or component of a robotics device or system, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a camera, or other device. In some aspects, the computing device, apparatuses, and/or vehicle includes one or more sensors (e.g., one or more range sensors, such as one or more LIDAR sensors, one or more accelerometers, any combination thereof, and/or other sensor).

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided for illustration of the aspects and not limitation thereof

FIG. 1 is a simplified block diagram illustrating an example of a range sensor processing system, in accordance with some examples of the present disclosure;

FIG. 2A is a graph illustrating an example of a range sensor in a simulated, two-dimensional environment, in accordance with some examples;

FIG. 2B is a graph illustrating original and reconstructed noiseless range measurements corresponding to the environment in FIG. 2A, in accordance with some examples;

FIG. 2C is a graph illustrating wavelet coefficients for noiseless range measurement function and threshold used for reconstruction, in accordance with some examples;

FIG. 3A is graph illustrating linear velocity error as a function of measurement noise standard deviation, in accordance with some examples;

FIG. 3B is a graph illustrating angular velocity error as a function of measurement noise standard deviation, in accordance with some examples;

FIG. 4A is graph illustrating linear velocity error as a function of the number of measurements, in accordance with some examples;

FIG. 4B is a graph illustrating angular velocity error as a function of the number of measurements, in accordance with some examples;

FIG. 5A is graph illustrating linear velocity error as a function of the angular velocity of the sensor, in accordance with some examples;

FIG. 5B is a graph illustrating angular velocity error as a function of the angular velocity of the sensor, in accordance with some examples;

FIG. 6A is graph illustrating linear velocity error as a function of the linear velocity of the sensor, in accordance with some examples;

FIG. 6B is a graph illustrating angular velocity error as a function of the linear velocity of the sensor, in accordance with some examples;

FIG. 7A is a graph illustrating a sample point cloud for a range sensor scan, in accordance with some examples;

FIG. 7B is a representation of an image corresponding to the scan for FIG. 7A, in accordance with some examples;

FIG. 8A is a graph illustrating a linear velocity profile, in accordance with some examples;

FIG. 8B is a graph illustrating an angular velocity profile, in accordance with some examples;

FIG. 9A is a graph illustrating linear velocity error with additional synthetic noise, in accordance with some examples;

FIG. 9B is a graph illustrating angular velocity error with additional synthetic noise, in accordance with some examples;

FIG. 10A is a graph illustrating linear velocity error with data subsampling, in accordance with some examples;

FIG. 10B is a graph illustrating angular velocity error with data subsampling, in accordance with some examples;

FIG. 11 is a flowchart illustrating an example of a method for processing range sensor data, in accordance with some examples; and

FIG. 12 is a block diagram illustrating an example of a computing system, in accordance with some examples.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Range sensors are used in a wide variety of applications or systems, such as mobile robotics, autonomous vehicles, aviation systems (e.g., drones or unmanned aerial vehicles, etc.), among other applications or systems. As discussed herein, range sensors can include a variety of sensor types, including but not limited to Light Detection and Ranging (LiDAR), laser range finders, radars, ultrasonic sensors, and/or infrared (IR) sensors, etc. Range sensors may be solid-state devices, and can be configured to operate in a variety of physical configurations. For example, range finders may be fixed in space, or may be configured to rotate/scan a particular field of view. In operation, range sensors can be used to perform localization of a mobile robot, vehicle, aviation system, etc.

Using range sensor data for localization leads to a scan-matching problem, which aims to estimate a system's motion from range measurements taken over a time interval. These measurements may be in the form of range scans of the environment, in which case the scan-matching problem is to estimate the system's displacement between two such scans. The scan-matching problem is an instance of a simultaneous localization and mapping (SLAM) problem; in order to estimate the motion of the system (referred to as ego motion), an estimate of the environment in which the system is located may be obtained.

Solutions to the scan matching problem can be grouped into a local class (using local models) and a global class (using global models). While local models and global models both assume that targets are static, there are differences in the assumptions relating to the environment being scanned. For example, local models make localized assumptions about the environment that present a correspondence problem. For instance, some local models make the assumption that a point in a new scan corresponds to a nearby point in a previous scan or that a point in a new scan corresponds to a nearby planar patch in a previous scan. As such, local models are limited to consideration of two scans or frames (e.g., including respective point clouds) and may only solve for points that correspond between the two scans or frames (e.g., points must be detected across the two scans or frames). A global model avoids the correspondence problem by considering and/or describing the environment in its entirety.

An example of a local model is a point-to-point iterative-closest point (ICP) algorithm. The ICP algorithm makes no assumptions about the environment. Point-to-point ICP constructs two point clouds from two range scans, which can present a correspondence problem. For instance, the correspondence problem can refer to the problem of determining a correspondence of data points from two or more data sets (e.g., two scans, frames, point clouds, etc.) that differ due to movement of a sensor, movement of an object, elapse of time, etc. Point-to-point ICP solves the correspondence problem by finding, for each point in the second data set (e.g., second point cloud), the closest point in the data set (e.g., the first point cloud). These point-point pairs are then used to estimate a motion of a system (e.g., a mobile robot, a vehicle, etc.), such as a system that includes the range sensor(s).

Point-to-line and point-to-plane ICP are other examples of local models that provide local scan-matching solutions. The point-to-line/plane ICP constructs two data sets (e.g., point clouds) from the scans. The correspondence problem is slightly simpler and includes finding for each point in the second data set (e.g., the second point cloud) the closest line/plane through points in the first data set (e.g., the first point cloud). These point-line/plane pairs are then used to estimate motion of a system (e.g., a mobile robot, a vehicle, etc.), such as a system that includes the range sensor(s). The point-to-line/plane ICP algorithms assume that the environment is locally linear.

The basic point-to-point ICP algorithm associates every point (or less than all points in some cases) in a second data set (e.g., a second scan, frame, point cloud, etc.) with the closest point in a first data set (e.g., a first scan, frame, point cloud, etc.) and then solves for pose transformation that minimizes the distances between corresponding points. The point-to-line and point-to-plane ICP algorithms minimize the distances of the transformed point to the tangent line or plane at the corresponding point. A plane-to-plane ICP algorithm is a further improvement that considers planar models in both scans. As mentioned earlier, the ICP scan-matching algorithms make local model assumptions about the environment.

Multi-scan variants of these algorithms build on top of pairwise ICP. Specifically, certain multi-scan variants of these algorithms propose to forward-register previous point clouds to build up a denser and denser current point cloud.

Global scan-matching solutions make a global model assumption about the environment. A global model can be used to predict measurements (e.g., position measurements) without solving a correspondence problem. An algorithm that utilizes a global model can be used to jointly solve for the motion of a system and parameters of the global environment model. Existing global scan-matching solutions are tailored to specific applications, such as for aerial terrain mapping or for handwritten character recognition.

While local models are simpler than global models because they only make local assumptions about the environment and are associated with a lower computational cost, they require the solution of a correspondence problem. Solving the correspondence problem can be sample inefficient and can lead to less noise tolerance. In addition, local models provide less accurate results because of motion distortion (e.g., the effect of motion of the sensor during the collection of a scan).

Global models can have the disadvantage of higher computational cost and require stronger assumptions about the environment. Developing an appropriate global model can be a challenge and currently exist for specific applications. However, global scan-matching solutions have the advantage of being correspondence free. As a result, a global scan-matching solution would be more sample efficient, have greater noise tolerance, and unaffected by motion distortion.

Other approaches perform scan matching using flow constraints to explain the evolution of the range scans as the sensor moves. However, these methods are also essentially local, in that the flow constraint is an implicit local environment model.

While there are many different local scan-matching methods, there are far fewer global scan-matching methods. These global model based methods assume structure over larger portions of the environment. One example uses a global scan-matching method for aerial terrain mapping from range data. It employs a smooth two-dimensional (2-D) spline to model terrain height. Other global scan-matching methods that have been employed for tasks such as handwritten character recognition and surface matching in three-dimensional (3-D) modeling.

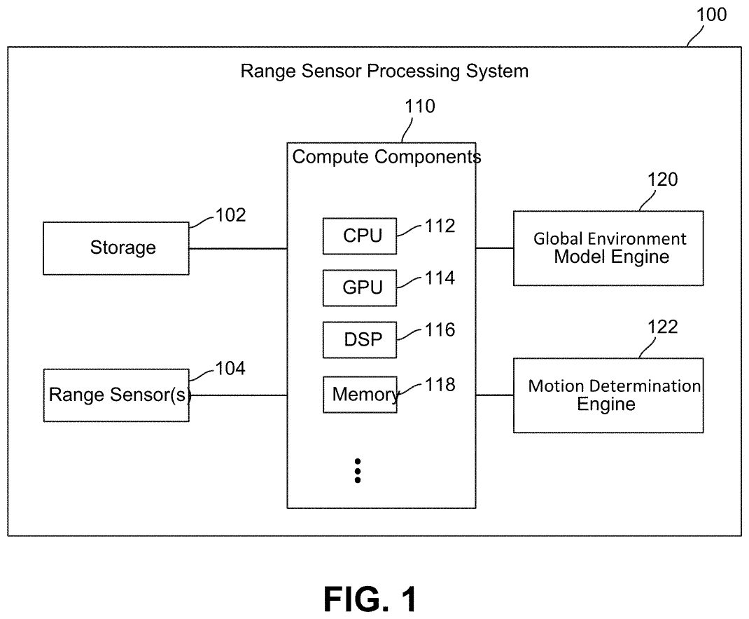

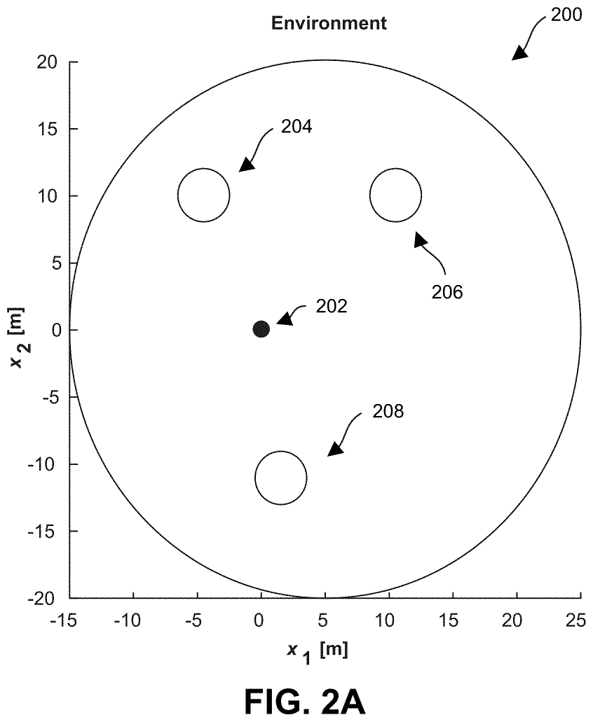

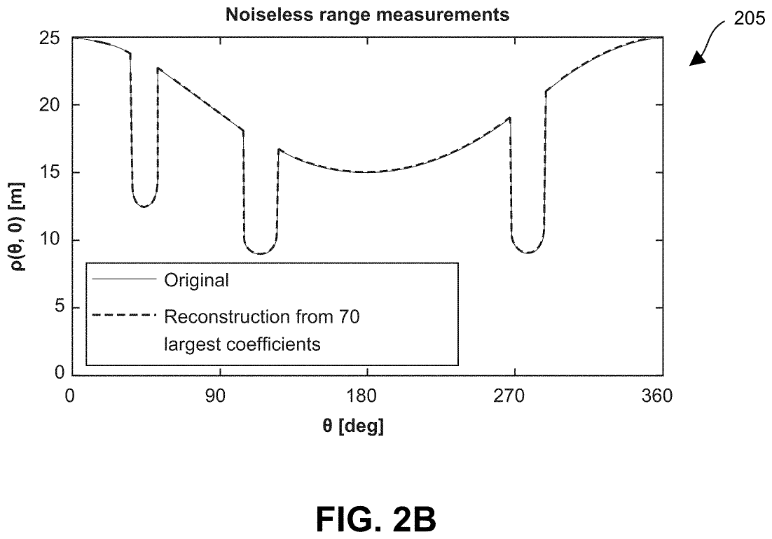

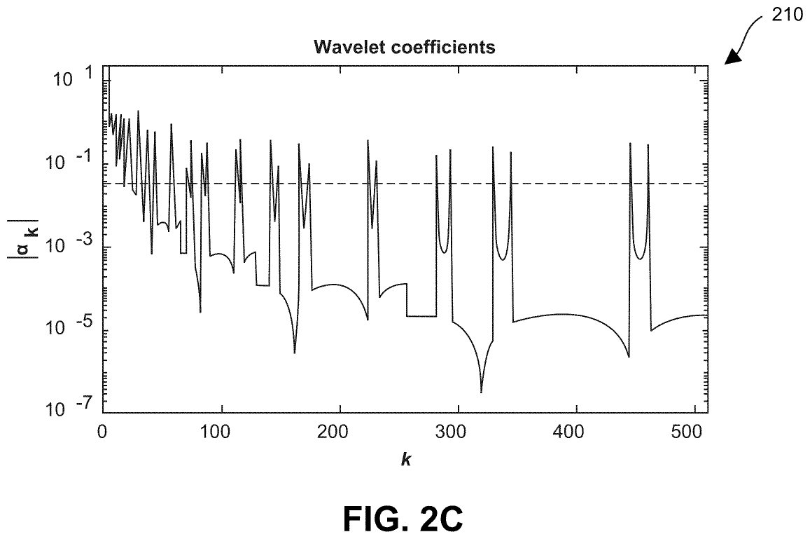

Systems, apparatuses, methods (also referred to as processes), and computer-readable media (collectively referred to as “systems and techniques”) are described herein that provide a global model based solution for processing range sensor data. FIG. 1 is a diagram illustrating an example of a range sensor processing system 100 according to aspects of the present disclosure. The range sensor processing system 100 can implement the systems and techniques disclosed herein, including aspects described below with respect to FIGS. 2A-11.

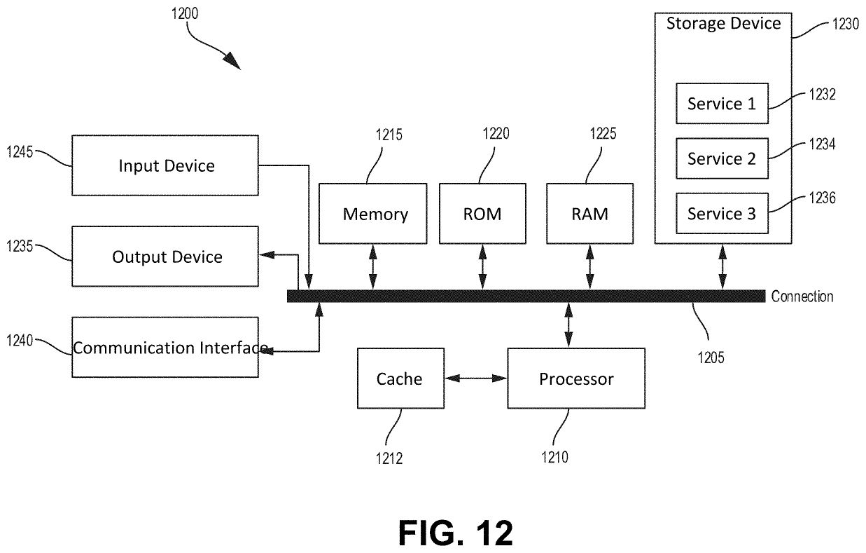

In the example shown in FIG. 1, the range sensor processing system 100 includes storage 102, one or more range sensors 104, compute components 110, a global environment model engine 120, and a velocity determination engine 122. It should be noted that the components 102 through 122 shown in FIG. 1 are non-limiting examples provided for illustration and explanation purposes, and other examples can include more, less, and/or different components than those shown in FIG. 1. For example, in some cases the range sensor processing system 100 can include one or more display devices, one or more cameras (e.g., configured to capture color images, such as red-green-blue (RGB) images), one more other processing engines, and/or one or more other software and/or hardware components that are not shown in FIG. 1. An example architecture and example hardware components that can be implemented by the range sensor processing system 100 are further described below with respect to FIG. 12.

References to any of the components of the range sensor processing system 100 in the singular or plural form should not be interpreted as limiting the number of such components implemented by the range sensor processing system 100 to one or more than one. For example, references to a processor in the singular form should not be interpreted as limiting the number of processors implemented by the range sensor processing system 100 to one. One of ordinary skill in the art will recognize that, for any of the components shown in FIG. 1, the range sensor processing system 100 can include only one of such component(s) or more than one of such component(s).

The range sensor processing system 100 can be part of, or implemented by, a single computing device or multiple computing devices. In some examples, the range sensor processing system 100 can be part of an electronic device (or devices) such as a vehicle or a computing device or component of a vehicle (e.g., an autonomous vehicle), a robotics device or system or a computing device or component of a robotics device or system, a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal or desktop computer, a laptop computer, a server computer, a camera, or other device, a smart television, a display device, a gaming console, a video streaming device, an Internet-of-Things (IoT) device, or any other suitable electronic device(s).

In some implementations, the storage 102, one or more range sensors 104, compute components 110, global environment model engine 120, velocity determination engine 122 and can be part of the same computing device. For example, in some cases, the storage 102, compute components 110, global environment model engine 120, and velocity determination engine 122 can be integrated into a computing device or component of a vehicle, and XR device, mobile device, and/or any other computing device. In other implementations, the storage 102, compute components 110, global environment model engine 120, and velocity determination engine 122 can be part of two or more separate computing devices. For example, in some cases, some of the components 102 through 122 can be part of, or implemented by, one computing device and the remaining components can be part of, or implemented by, one or more other computing devices.

The storage 102 can be any storage device(s) for storing data. In some cases, the storage 102 can store data from any of the components of the range sensor processing system 100. For example, the storage 102 can store data from the one or more range sensors 104, data from the compute components 110, data from the global environment model engine 120, and/or data from the velocity determination engine 122. In some examples, the storage 102 can include one or more buffers and/or caches for storing data for processing by the compute components 110. In some examples, the one or more buffers and/or caches can be general-use and available to some (or all) of the compute components 110. In some examples, the one or more buffers and/or caches can be provided specific to particular ones of the compute components 110.

The compute components 110 can include a central processing unit (CPU) 112, a graphics processing unit (GPU) 114, a digital signal processor (DSP) 116, and a memory 118. In some implementations, the compute components 110 can include other processors or compute components, such as one or more digital signal processors (DSPs), one or more neural processing units (NPUs), one or more buffers and/or cache, and/or other processors or compute components. The compute components 110 can perform various operations, such as those described below (e.g., with respect to FIGS. 2A-11).

In some cases, operations of one or more of the global environment model coefficient determination engine 120 and the velocity determination engine 122 can be executed by one or more combinations of CPU 112, GPU 114, DSP 116, and/or other processing or computing component. In some cases, the compute components 110 can include other electronic circuits or hardware, computer software, firmware, or any combination thereof, to perform any of the various operations described herein.

The range sensor processing system 100 can process range sensor data (e.g., including measurements) from the one or more range sensors 104. The one or more range sensors 104 may include one or more Light Detection and Ranging (LiDAR), one or more laser range finders, one or more radars, one or more ultrasonic sensors, one or more infrared (IR) sensors, any combination thereof, and/or other range sensors. For example, the range sensor processing system 100 may utilize the LIDAR sensors, laser range finders, and/or other range sensors for autonomous vehicle navigation, for indoor and outdoor mobile systems (e.g., mobile robots, vehicles, aviation systems, etc.), for aerial surveys using helicopter drones, and/or for any other application. In some aspects, the systems and techniques can perform or utilize scan matching for a wide range of applications with range sensors of different capabilities. In some implementations, the one or more range sensors 104 are not part of the range sensor processing system 100, in which case the range sensor processing system 100 is communicatively coupled to the one or more range sensors 104 so that the range sensor processing system 100 is able to receive sensor data from the one or more range sensors 104. In some aspects, the one or more range sensors 104 can be mounted to a mobile object or system (e.g., robot, vehicle, etc.). In some cases, the one or more range sensors 104 can be configured to rotate 360 degrees. In some aspects, the one or more range sensors 104 may be or otherwise include solid-state devices. In other examples, one or more of the range sensors 104 may be fixedly attached and directed to a particular direction.

In some examples, the global environment model engine 120 of the range sensor processing system 100 can generate and/or update a global model of an environment using the range sensor data. In some cases, the global environment model engine 120 can determine, based on a sparsity constraint, coefficients corresponding to a sparse basis expansion of the global environment model. For instance, the basis expansion is sparse because it has sparse coefficients (e.g., most coefficients are zero), such as shown and described below with respect to FIG. 2B and FIG. 2C. In some examples, the sparse basis expansion comprises a wavelet expansion and the plurality of coefficients comprise a plurality of wavelet coefficients. Other expansions and coefficients can be used in other examples, such as curvelet, contourlet, etc. For instance, in some aspects, the sparse basis expansion can include a wavelet expansion, a curvelet expansion, a contourlet expansion, any combination thereof, and/or other expansions. Similarly, the coefficients can include wavelet coefficients, curvelet coefficients, contourlet coefficients, any combination thereof, and/or other coefficients.

The velocity determination engine 122 can determine a motion corresponding to a range sensor of the one or more range sensors 104. In some cases, the motion can include a linear velocity and/or an angular velocity corresponding to the range sensor of the one or more range sensors 104. For instance, the velocity determination engine 122 can determine a linear velocity and/or an angular velocity based on the global environment model, the plurality of coefficients, and the range sensor data (e.g., the range sensor measurements) from the range sensor(s) 104. In some cases, such as when the one or more range sensors 104 are attached or mounted to a mobile object or system (e.g., robot, vehicle, etc.), the linear velocity and/or angular velocity can correspond to the motion of the mobile object or system.

In some cases, the global environment model engine 120 can determine a range function based on the plurality of coefficients. In some cases, the range function is a piecewise smooth function having a finite number of discontinuities. In some cases, the plurality of coefficients includes at least one coefficient corresponding to at least one discontinuity in the range function (e.g., the discontinuities shown in FIG. 2B that correspond to one or more of the coefficients shown in FIG. 2C).

In some examples, the range sensor data from the one or more range sensors 104 can be used to identify one or more objects in a surrounding environment. In some examples, the range sensor data from the one or more range sensors 104 can be used to generate indoor and/or outdoor maps of an environment. In some configurations, the one or more range sensors 104 may be coupled to an apparatus that includes one or more wireless transceivers and may derive a location based on Global Navigation Satellite System (GNSS), Inertial Measurement Unit (IMU), LIDAR, Wireless Wide Area Network (WWAN), Wi-Fi, Bluetooth, Bluetooth Low Energy (BLE), any other suitable sensor/device, or any combination thereof. In other aspects, a range sensor may include one or more wireless transceivers and/or modems (e.g., a range sensor can have capability of performing mmWave communications).

In some examples, the range sensor data or data derived from the range sensor(s) 104 can be sent to one or more servers (e.g., edge server) for storage and/or additional processing. In some aspects, one or more servers can process data derived from the range sensor(s) 104 to create, develop, and/or enhance one or more maps (e.g., high definition (HD) maps). In some cases, an apparatus may transmit/receive range sensor data or measurements from the range sensor(s) 104 with another apparatus (e.g., to coordinate measurements). In one illustrative example, a vehicle with one or more range sensors (e.g., the range sensor(s) 104) may communicate with another vehicle to exchange data and/or measurements (e.g., using cellular vehicle-to-everything (V2X), such as Long Term Evolution (LTE)-V2X or 5G/New Radio (NR)-V2X).

According to the systems and techniques described herein, the global model generated or updated by the global environment model engine 120 can avoid the correspondence problem by considering and/or describing the environment or scene in its entirety. As noted above, in some examples, the global environment model engine 120 can generate or represent (e.g., as shown by the right side of equation (11) provided below) the global model of the environment using a sparse basis expansion (e.g., wavelet expansion, curvelet expansion, contourlet expansion, etc.). Using the global model, the global environment model engine 120 can jointly process two or more frames of range sensor data obtained from an environment or a particular scene within the environment and can solve for the environment (e.g., the entire environment or a large portion of the environment) based on motion of an object (e.g., a robot, vehicle, etc.). In some cases, the velocity determination engine 122 can determine the motion, which in some implementations can include velocity (e.g., linear velocity and/or angular velocity) as describe above.

In some aspects, the global environment model engine 120 and/or the velocity determination engine 122 can observe a particular scene within the environment during a period of time in which the environment is being observed (e.g., as data is collected by one or more range sensors) relative to a frame of reference or pose. In one illustrative example, the scene within the environment can be observed during a timeframe from −0.5 seconds (s) to +0.5 s in which a world frame is chosen to be the body pose of the object (e.g., the robot, vehicle, etc.) at time t=0. Examples of scenes having shorter or longer durations are contemplated and can be processed in accordance with the systems and techniques disclosed herein. In some cases, the time period associated with a particular scene can be selected according to factors such as visibility of targets in the scene (e.g., occlusions), speed of one or more sensors (e.g., speed of rotation) such a sensor on or integrated with the object (e.g., one or more inertial measurement units (IMUs), such as a gyroscope and/or accelerometer, for instance configured to measure the pitch, roll, and yaw of the object), movement of the one or more sensors (e.g., corresponding to movement or speed of the object, such as a robot, vehicle, etc.), distance from the one or more sensors to one or more targets (e.g., distance to nearest target), measurement rate, any combination thereof, and/or other factors. In some aspects, one or more scenes can be considered and each instance of a scene can have a corresponding world frame (e.g., selected at or near the center of the time-window).

A specific illustrative example will now be provided, where a range sensor (e.g., a LIDAR sensor or other sensor of the range sensor(s) 104) is mounted on a moving platform (e.g., a vehicle, a robot, a mobile device, or other device) with position x(t)∈ [symbol] ³ and with orientation represented by a rotation matrix R(t)∈ [symbol] ^{3×3} at time t. The trajectory of the platform may be expressed with respect to its body pose at time t=0 (e.g., the world frame), so that x(0)=0 and R(0)=I. In some aspects, time t=0 can correspond to a time at or near the middle of time range during which a scene is observed. For instance, a scene can be observed during a period of time (e.g., 1 second) in which the range sensor takes measurements and its world frame can correspond to a pose at a time near the middle of the time frame for the scene (e.g., the world frame can be selected according to the scene). In one illustrative example, a scene can be observed during a timeframe from −0.5 seconds (s) to +0.5 s, where the world frame is chosen to be the body pose of the object (e.g., the vehicle, robot, etc.) at time t=0. As noted above, the time frame associated with a scene may be based on factors such as visibility of targets (e.g., occlusions), speed of a sensor (e.g., speed of rotation), movement of a sensor (e.g., movement or speed of vehicle, robot, etc.), distance from a sensor to target(s) (e.g., distance to nearest target), measurement rate, or any combination thereof

Denoting by ν(t)∈ [symbol] ³ and ω(t)∈ [symbol] ³ the linear and angular velocities of the platform expressed in the platform body frame at time t, the following standard relations can be applied:

\dot{x}(t)=R(t)ν(t) Equation (1a)

\dot{R}(t)=R(t)[ω(t)×]. Equation (1b)

Here, [·33 ] maps a vector to the skew-symmetric 3×3 matrix that defines the cross product, which can be denoted as a×b=[a×]b.

Expressions may require transforming between Cartesian and spherical coordinate systems. For example, the point x in Cartesian coordinates can be denoted by (Tᵣ(x), T_{θ}(x)) using spherical coordinates, in which the r can correspond to a range, θ₁ can correspond to an azimuth angle, and θ₂ can correspond to an elevation angle. Conversely, given spherical coordinates (r, θ), the corresponding Cartesian coordinates are Tₓ (r, θ).

Considering a static point target (e.g., a target that is not moving with respect to the world frame of reference) at position y∈R³ in the world frame, the range, azimuth, and elevation of the target as observed by the sensor at time t can be denoted as (r(y, t), θ(y, t)), which yields:

r(y,t) [symbol] Tᵣ(R^{T}(t)(y−x(t))),

θ(y,t) [symbol] T_{θ}(R^{T}(t)(y−x(t))),

In the example of a static target, the range, azimuth, and elevation as observed by the sensor at time t and at time 0 can be related as follows:

Tₓ(r(y,0),θ(y,0))=x(t)+R(t)Tₓ(r(y,t),θ(y,t))).

Expressed in spherical coordinates, this becomes:

r(y,0)=Tᵣ(x(t)+R(t)Tₓ(r(y,t),θ(y,t))), Equation (2a)

θ(y,0)=T_{θ}(x(t)+R(t)Tₓ(r(y,t),θ(y,t))). Equation (2b)

Denoting ρ(θ, t) as the noiseless range measurement of the sensor in the direction of azimuth θ₁, elevation θ₂, and at time t, and assuming y is the closest target in the direction θ at time t, the following result is yielded:

ρ(θ(y,t),t)=r(y,t). Equation (3)

Specializing equation (3) for t=0 and combining with equation (2), the relation can be rewritten as:

$$ρ ( {T}_{θ} ( x ( t ) + R ( t ) {T}_{x} ( r ( y , t ) , θ ( y , t ) ) ) , 0 ) = {T}_{r} ( x ( t ) + R ( t ) {T}_{x} ( r ( y , t ) , θ ( y , t ) ) ) . \qquad Equation ( 4 )$$

In one example, there may be no occlusions in a scene (at least with respect to the target y), in which case the target y is still visible at time t within the scene. In one example, target y can refer to a part of a real-world object that was sensed at t=0. In this case, equation (3) is still valid for the same y at time t and ρ(θ(y, t), t) can be substituted for both occurrences of r(y), t) in equation (4) to yield:

$$ρ ( {T}_{θ} ( x ( t ) + R ( t ) {T}_{x} ( ρ ( θ ( y , t ) , t ) , θ ( y , t ) ) ) , 0 ) = {T}_{r} ( x ( t ) + R ( t ) {T}_{x} ( ρ ( θ ( y , t ) , t ) , θ ( y , t ) ) ) . \qquad Equation ( 5 )$$

In some aspects, equation (5) can hold for all values of y (e.g., assuming static targets and ignoring occlusions). In some cases, the equation (5) can be re-written in terms of a general azimuth θ₁ and elevation θ₂. This can be done by the substitution θ [symbol] θ(y, t). It is noted that this substitution does not require the sensor to observe every value of y at all time. In one aspect, making the substitution can yield:

$$Equation ( 6 )$$

$$ρ ( {T}_{θ )} ( x ( t ) + R ( t ) {T}_{x} ( ρ ( θ , t ) , θ ) ) , 0 ) = {T}_{r} ( x ( t ) + R ( t ) {T}_{x} ( ρ ( θ , t ) , θ ) ) .$$

Equation (6) provides an (implicit) constraint on the noiseless sensor measurement ρ(θ, t) at time t as a function of the noiseless sensor measurement ρ(θ′, 0) at a modified angle at time 0.

The range function ρ(·, 0) at time 0 can be expressed in a basis expansion of the form as follows:

$$ρ ( θ , 0 ) = exp ( {\sum }_{k = 1}^{∞} {α}_{κ} {ψ}_{κ} ( θ ) ) \qquad Equation ( 7 )$$

where ψₖ: [symbol] ²→ [symbol] are the basis functions and αₖ∈ [symbol] are the coefficients. Such an expansion is possible under fairly weak conditions, e.g., that log(ρ(·, 0)) is square-integrable. Using an expansion for log(ρ(·, 0)) in equation (7) rather than directly for ρ(·, 0) can provide benefits because the right-hand side of equation (7) is nonnegative for any choice of coefficients (αₖ)ₖ₌₁^{∞}. Substituting equation (7) into equation (6) results in the following:

$$exp ( {\sum }_{k = 1}^{∞} {α}_{k} {ψ}_{k} ( {T}_{θ} ( x ( t ) + R ( t ) {T}_{x} ( ρ ( θ , t ) , θ ) ) ) ) = {T}_{r} ( x ( t ) + R ( t ) {T}_{x} ( ρ ( θ , t ) , θ ) ) . \qquad Equation ( 8 )$$

The range sensor produces measurements of the form (tₙ, θₙ, \tilde{ρ}ₙ) satisfying the relationship:

\tilde{ρ}ₙ=ρ(θₙ,tₙ)+zₙ,

where zₙ is modeled as additive white Gaussian noise with mean 0 and variance σ². Note that the timestamp tₙ and the direction θ are assumed to be known without noise. A formulation of the scan-matching problem can then be determined. For example, given the noisy samples (tₙ, θₙ, \tilde{ρ}ₙ), n∈{1, 2, . . . , N} and knowing the basis functions (ψₖ)ₖ₌₁^{∞}, the range sensor processing system 100 (e.g., the global environment model engine 120 and/or the motion determination engine 122) can estimate the platform trajectory (x(·),R(·)) and the environment coefficients (αₖ)ₖ₌₁^{∞}.

Without any further constraints, this problem is under-constrained and may not be solvable. To render the problem as being more well posed, the platform motion and the environment can be constrained. For the platform motion, it can be assumed that the linear velocity (ν(t)=ν and the angular velocity ω(t)=ω in (1) are constant. The dynamics of equation (1) therefore become:

[symbol]

(t)=R(t)ν, Equation (9a)

\dot{R}(t)=R(t)[ω×]. Equation (9b)

To emphasize this relation, the relations x(t)=x_{ν,ω}(t) and R(t)=R_{ν,ω}(t) are used in the following. The system of differential equations (9) for the platform pose has the closed-form solution:

$$( \begin{matrix}{R}_{v , ω} ( t ) & {x}_{v , ω} ( t ) \\ 0 & 1\end{matrix} ) = exp ( \begin{matrix}[ ω \times ] t & ν t \\ 0 & 0\end{matrix} ) \qquad Equation ( 10 )$$

where exp(·) denotes the matrix exponential.

For the environment, the function ρ(θ, 0) is assumed to be piecewise smooth because reflections that are measured by a range sensor tend to be from discrete objects yielding a piecewise smooth range profile as a function of view angles. FIG. 2A and FIG. 2B provide illustrative examples. FIG. 2A is a graph 200 illustrating a range sensor (represented by the black dot 202) in a simulated 2-D environment with multiple objects (including object 204, object 206, and object 208). FIG. 2B is a graph 205 illustrating the original (as a solid line) and reconstructed (as a dotted line tracking the solid line) noiseless range measurements. As shown in FIG. 2B, the range profile is piecewise smooth, with occasional discontinuities. Under this assumption, an appropriate choice for the ψₖ in equation (7) can be the wavelet basis. Other expansions can also be used, such as a curvelet basis, a contourlet basis, any combination thereof, and/or other expansions. For example, for the 3-D case x∈ [symbol] ³ can have ρ(·, 0): [symbol] ²→ [symbol] , and the curvelet basis (or other basis such as the contourlet basis) can be used. For the 2-D case x∈ [symbol] ² can have ρ(·, 0): [symbol] → [symbol] and a traditional wavelet basis can be used. In one aspect, selection of a traditional wavelet basis can cause the resulting coefficients to be approximately sparse. FIG. 2C is a graph 210 illustrating the wavelet coefficients for noiseless range measurement function and threshold used for reconstruction. As shown in the graph 210 of FIG. 2C, the resulting coefficients are approximately sparse based on the use of wavelet coefficients using a wavelet basis. As a consequence, the range function ρ(θ, 0) can be well approximated using only a subset of the coefficients in the expansion. An example of using a subset of coefficients is shown in the graph 205 of FIG. 2B, where the reconstructed range measurements are based on the 70 largest coefficients. It is noted that 70 coefficients were selected as an illustrative example corresponding to FIG. 2B, and the range sensor processing system 600 is not limited by a selection of a particular number of coefficients. In some examples, the cardinality | [symbol] | can be selected based on factors such as the sensing setup, sensing environment, number of sensors, etc. The relation in equation (7) can therefore be approximated as:

$$ρ ( θ , 0 ) \approx exp ( {\sum }_{k ϵ𝒦} {α}_{k} {ψ}_{k} ( θ ) ) \qquad Equation ( 11 )$$

for some [symbol] ⊂{1, 2, . . . } with small cardinality | [symbol] |. Note that this is a nonlinear approximation of log(ρ(·, 0)) as the set of indices [symbol] used in equation (11) depends on the function being approximated. In some aspects, the right side of equation (11) can correspond to a global environment model based on a sparse basis expansion (e.g., based on the alpha vector αₖ acting as a sparsity constraint on the coefficients) and the left side of equation (11) can correspond to a range function.

With these assumptions, the relation of equation (8) can be written as:

$$exp ( {\sum }_{k ϵ 𝒦} {α}_{k} {ψ}_{k} ( {T}_{θ} ( {x}_{v , ω} ( t ) + {R}_{v , ω} ( t ) {T}_{x} ( ρ ( θ , t ) , θ ) ) ) ) \approx {T}_{r} ( {x}_{v , ω} ( t ) + {R}_{v , ω} ( t ) {T}_{x} ( ρ ( θ , t ) , θ ) ) \qquad Equation ( 12 )$$

where [symbol] is a finite set of indices, which permits solving the scan-matching problem from a finite number of samples. The approximation error in equation (12) can be ignored and it can be assumed that this relation holds with equality.

Using equation (12), solving for the (e.g., generalized) maximum likelihood estimate of the platform dynamics parameters (ν, ω), the environment parameters α [symbol] (αₖ)ₖ₌₁^{∞}, and the noiseless ranges ρ [symbol] (ρₙ)ₙ₌₁^{N} from the noisy sensor measurements (tₙ, θₙ, \tilde{ρ}ₙ)ₙ₌₁^{N} can be performed as follows:

$${minimize}_{v , ω , a , ρ} {\sum }_{n = 1}^{N} {( {ρ}_{n} - {\tilde{ρ}}_{n} )}^{2} subject to {‖ α ‖}_{0} \leq \vert 𝒦 \vert , {g}_{v , ω , α} ( {t}_{n} , {θ}_{n} , {ρ}_{n} ) = 0 , \qquad Equation ( 13 )$$

$$∀ n ϵ \{ 1 , 2 , … , N \}$$

where ∥α∥₀ denotes the [symbol] ₀ “norm” of α defined as its number of non-zero entries, and where the following is defined:

$$Equation ( 14 )$$

$${g}_{v , ω , α} ( t , θ , ρ ) {=}^{△} exp ( {\sum }_{k = 1}^{∞} {α}_{k} \text{} {ψ}_{k} ( \text{} {T}_{θ} \text{} {x}_{v , ω} ( t ) + {R}_{v , ω} ( t ) {T}_{x} ( ρ ( θ ) ) ) ) \text{} - {T}_{r} ( \text{} {x}_{v , ω} ( t ) + {R}_{v , ω} ( t ) {T}_{x} ( ρ ( θ ) )$$

The domain of each basis function ψₖ in equation (13) is the bounded but uncountable set [0, 2π)². In order to be able to solve this problem numerically, the domain can be discretized to K uniformly spaced grid points. The dimension K is chosen to be larger than the cardinality of [symbol] . For example, in the example of FIG. 2A-FIG. 2C, K=512 and | [symbol] |=70. In some aspects, the ratio of the cardinality of [symbol] to the dimension K can be approximately twenty percent or lower.

With this discretization, the number of required wavelet basis functions reduces to K. The function g in equation (14) can be redefined as:

$$\begin{matrix} & \\ {g}_{v , ω , α} ( t , θ , ρ ) {=}^{△} exp \text{} ( {{\sum }^{K}}_{k = 1} {a}_{k} {ψ}_{k} ( {T}_{θ} ( {x}_{v , ω} ( t ) + {R}_{v , ω} ( t ) {T}_{x} ( ρ ( θ ) ) ) ) - {T}_{r} ( {x}_{v , ω} ( t ) + {R}_{v , ω} ( t ) {T}_{x} ( ρ , θ ) ) . & Equation ( 15 )\end{matrix}$$

The sum over kin equation (15) can be computed efficiently using iterated filter banks or the (inverse) discrete wavelet transform. It should be noted that the domain of ψₖ in equation (15) is a discrete set of K points in [0, 2π)². Since its arguments in equation (15) can take any real value in [0, 2π)², the domain of the basis functions can be extended to [0, 2π)² via linear interpolation.

The [symbol] ₀ constraint in equation (13) turns it into a combinatorial optimization problem, which is intractable. One approach to address this issue is to relax the [symbol] ₀ “norm” to a [symbol] ₁ norm:

$${minimize}_{v , ω , α , ρ} {\sum }_{n = 1}^{N} {( {ρ}_{n} - {\tilde{ρ}}_{n} )}^{2} Subject to {‖ α ‖}_{1} \text{} \leq \vert \text{} 𝒦 \vert {g}_{v , ω , α} ( {t}_{n} , {θ}_{n} , {ρ}_{n} ) = 0 , \qquad Equation ( 16 )$$

$$∀ n ϵ \{ 1 , 2 , . . . , N \}$$

where ∥α∥ [symbol] Σₖ₌₁^{K} |α|. Equation (16) is a continuous optimization problem with 6+K+N variables and N constraints. Standard iterative optimization procedures can be used to find a locally optimal solution.

The number of variables in equation (16) grows linearly with the number of sensor measurements N. In some cases, this can be computationally burdensome. To further reduce the computational complexity, a Sampson approximation can be used for the constraints g_{ν,ω,α}(tₙ, θₙ, ρₙ)=0. For example, by linearizing the constraint around the sensor measurement \tilde{ρ}:

g_{ν,ω,α}(tₙ,θₙ,ρₙ)≈g_{ν,ω,α}(tₙ,θₙ,\tilde{ρ}ₙ)+ġ_{ν,ω,α}(tₙ,θₙ,\tilde{ρ}ₙ)·(ρₙ−\tilde{ρ}ₙ)

where

$$\dot{g} = \frac{\partial }{{\partial }_{p}} g .$$

With this approximation the constraint in equation (16) becomes:

g_{ν,ω,α}(tₙ,θₙ,\tilde{ρ}ₙ)+ġ_{ν,ω,α}(tₙ,θₙ,\tilde{ρ}ₙ)·(ρₙ−\tilde{ρ}ₙ)=0

which can be used to solve for the optimization variable ρₙ. Substituting into the objective function of equation (16) eliminates the optimization over ρ and the problem becomes:

$$Equation ( 17 )$$

$${minimize}_{v , ω , α} {\sum }_{n = 1}^{N} {( \frac{{g}_{v , ω , α} ( {t}_{n} , {θ}_{n} , {\tilde{ρ}}_{n} )}{{\dot{g}}_{v , ω , α} ( {t}_{n} , {θ}_{n} , {\tilde{ρ}}_{n} )} )}^{2} subject to {‖ a ‖}_{1} \leq \vert 𝒦 \vert$$

Equation (17) is a continuous optimization problem with only 6+K variables. This optimization problem can be referred to as the Sampson error minimization problem. Standard iterative optimization procedure can be used to find a locally optimal solution to this problem.

Equation (17) can be simplified by approximating the derivative ġ_{ν,ω,α}(tₙ, θₙ, \tilde{ρ}ₙ) as a constant independent of n. This reduces the optimization problem of (17) to:

$$Equation ( 18 )$$

$${minimize}_{v , ω , α} {\sum }_{n = 1}^{N} {g}_{v , ω , α}^{2} ( {t}_{n} , {θ}_{n} , {\tilde{ρ}}_{n} ) subject to {‖ a ‖}_{1} \leq \vert 𝒦 \vert$$

This optimization problem can be referred to as an algebraic error minimization problem. For fixed ν and ω, the algebraic error minimization problem is strictly convex in a and hence has a single local optimum, which is also the unique global optimum.

In order to initialize an iterative solver for either of the three optimization problems in Equations (16), (17), or (18), an initial value for the variables ν, ω and α can be used. Since all three problems are non-convex, the choice of the initial values for variables ν, ω and α can be made such that the solution is close or equal to the global optimum. Sufficient closeness to the global optimum can be expressed by a figure of merit (e.g., Euclidean distance or squared error). Initial values for ν and ω can be obtained from some prior estimates on the platform dynamics. Fixing ν and ω to their prior estimates, a good initial value for α can be found by solving the now convex reduced problem of equation (18) using standard solvers from any starting point α. Alternatively, using the prior values of v and co to transform a range scan to fixed time t=0 and then compute a wavelet decomposition for that transformed scan to obtain an initial (non-sparse) value of α.

In some aspects, two further modifications can be performed. For example, in order to solve the scan-matching problem numerically, the domain [0,2π)² of ψₖ was discretized using K discrete grid points. So far in the derivation, the error due to linear interpolation in equation (15) required to extend the domain of ψₖ from the grid to all of [0,2π)² has not been considered. In situations with small measurement noise, it can be important to take this error into account. Assuming an upper bound εₙ>0 on the interpolation error at the n-th sample point, the constraint in (16) can be replaced with:

|g_{ν,ω,α}(tₙ,θₙ,ρₙ)|≤εₙ

Correspondingly, the Sampson error minimization equation (17) can be modified as:

$${minimize}_{v , ω , α} {\sum }_{n = 1}^{N} {( \frac{max \{ 0 , \vert {g}_{v , ω , α} ( {t}_{n} , {θ}_{n} , {\tilde{ρ}}_{n} ) \vert - {ε}_{n} \}}{{\dot{g}}_{v , ω , α} ( {t}_{n} , {θ}_{n} , {\tilde{ρ}}_{n} )} )}^{2} subject to {‖ a ‖}_{1} \leq \vert 𝒦 \vert$$

and the algebraic error minimization problem in equation (18) can be:

$${minimize}_{v , ω , α} {\sum }_{n = 1}^{N} {( max \{ 0 , \vert {g}_{v , ω , α} ( {t}_{n} , {θ}_{n} , {\tilde{ρ}}_{n} ) \vert - {ε}_{n} \} )}^{2} subject to {‖ a ‖}_{1} \leq \vert 𝒦 \vert$$

Second, in order to increase the robustness to model errors and outliers (due for example to occlusions or moving objects), the squared error in the minimization problems can be replaced with a Huber loss. This loss function is quadratic for small errors and linear for large errors. In some examples, a small error is one that is less than a switch-over point from quadratic to linear. In some aspects, the switch-over point between the two regimes can be approximately the value of the measurement noise standard deviation σ.

The systems and techniques described herein relating to a global scan-matching approach can be compared to the two standard local scan-matching algorithms point-to-point ICP and point-to-line ICP. While the theoretical derivation is valid for both the 2-D and the 3-D settings, the focus here is on the 2-D case in which the motion is restricted to be on a plane and the angle θ is 1-D and represents azimuth.

Using synthetic data, a synthetic 2-D environment can be simulated to evaluate the systems and techniques described herein. The graph 200 of FIG. 2A illustrates an example of such a 2-D environment represented as a circular region containing circular objects 204, 206, and 208. In some examples, the simulation parameters can be based on the following: the pose of the platform is x(0)=0∈ [symbol] ² and R(0)−I∈ [symbol] ^{2×2} at time 0. The pose corresponds to a position close to the center of the large circular region of FIG. 2A. The platform moves at constant linear velocity ν∈ [symbol] ² and angular velocity ω∈ [symbol] . The simulation can assume to have access to a prior of ν corrupted by independent, identically distributed (i.i.d.) Gaussian noise with standard deviation 3/\sqrt{2} m/m and to a prior of ω corrupted by Gaussian noise with standard deviation 0.35 rad/s≈20°/s.

Platform motion can be simulated over the time period t∈[−0.5,0.5). Defining t=0 to be in the middle of the time period under consideration can be used, which can minimize occlusion effects. In some cases, the sensor takes measurements at an angle varying counterclockwise (or clockwise in other examples) with two revolutions per second measured with respect to the platform body frame. This rotation of the measurement angle is in addition to the angular velocity ω of the platform itself Thus, over the simulation time includes two full measurement revolutions when viewed in the body frame. In each revolution, the sensor takes 100 measurements, leading to a total of N=200 range measurements. The measurement noise has a standard deviation σ=0.01 m.

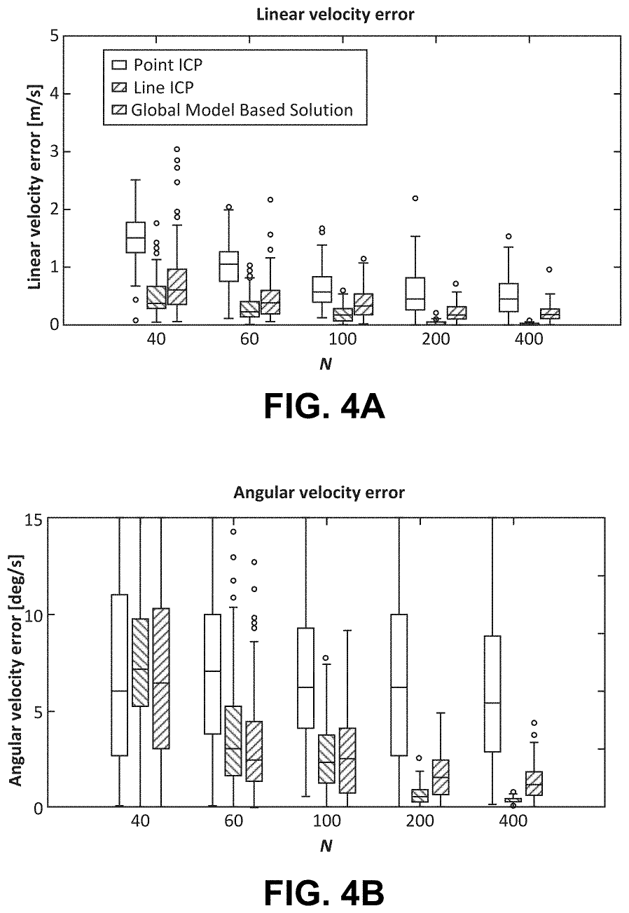

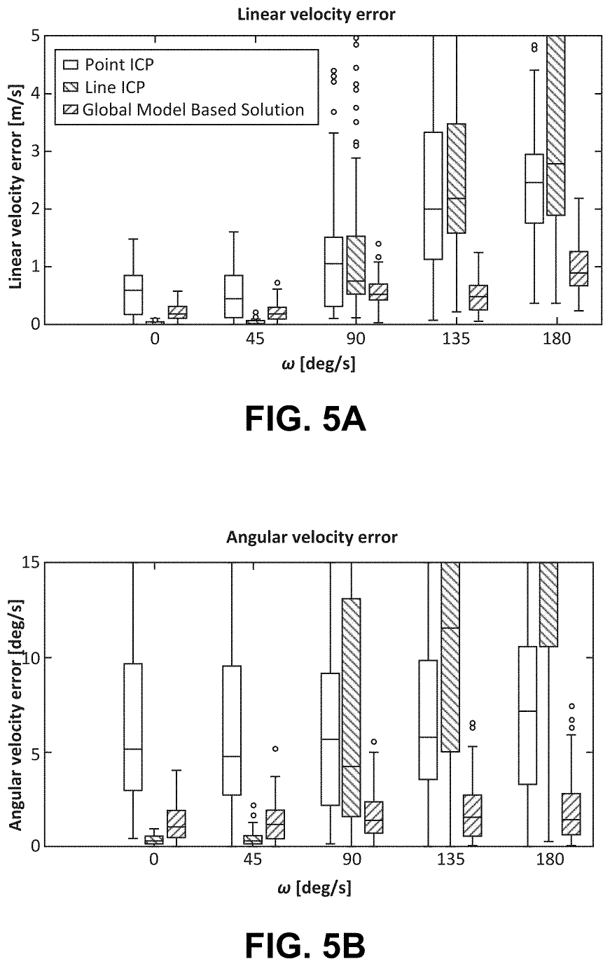

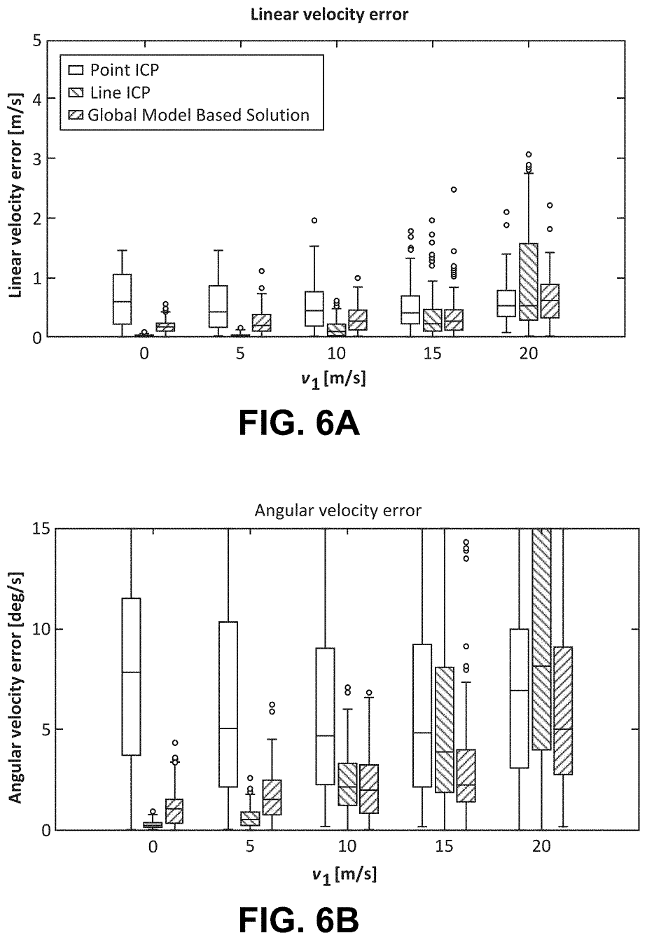

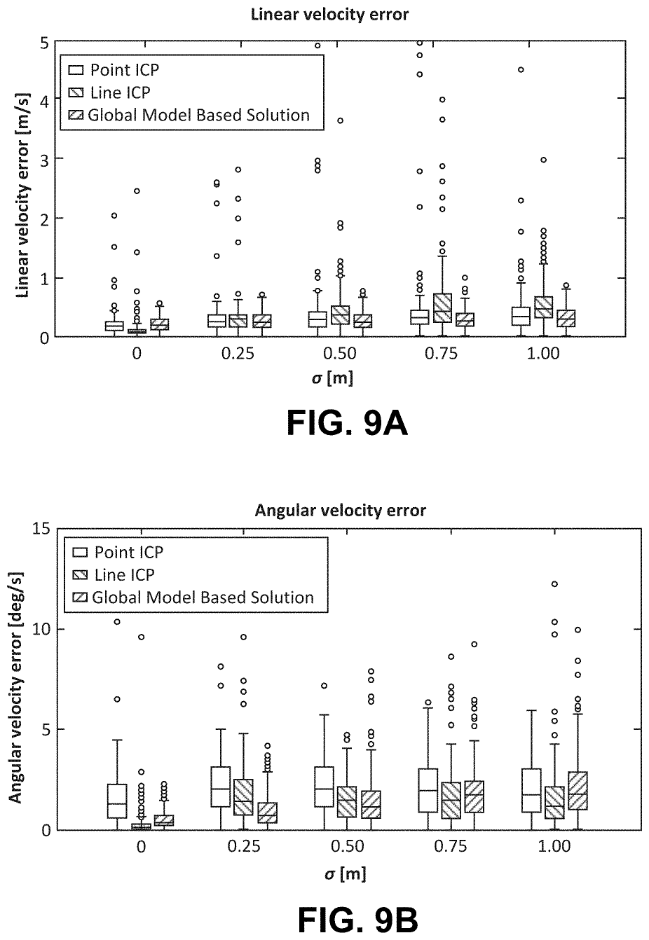

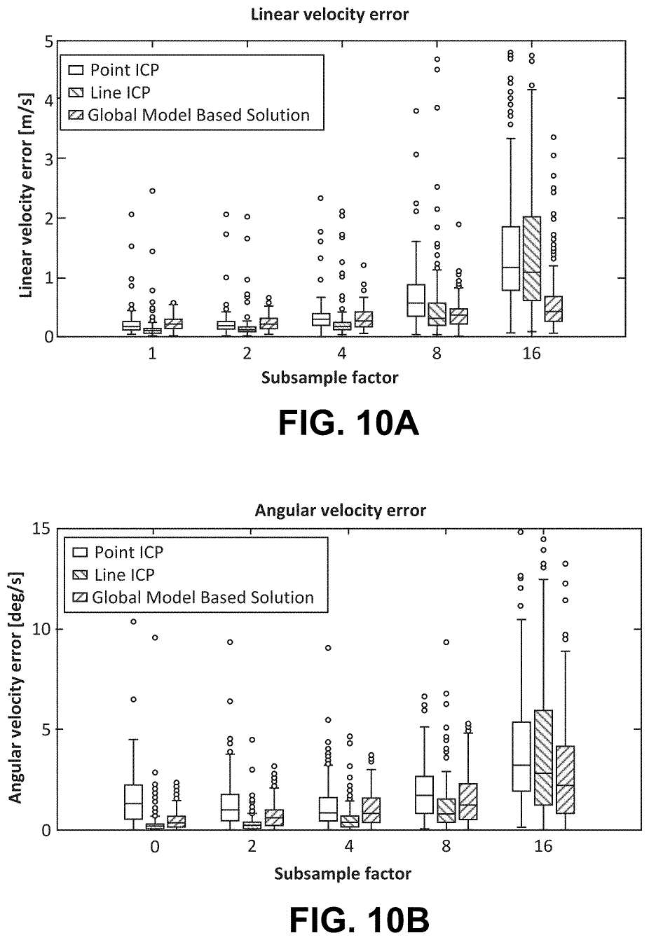

The techniques described herein can be compared to commercial implementations of point-to-point ICP, shown in FIG. 2A, FIG. 4A, FIG. 5A, FIG. 6A, FIG. 9A, FIG. 9B, FIG. 10A, and FIG. 10B (where the techniques described herein are labeled “global model based solution,” the point-to-point ICP is labeled “point ICP,” and point-to-line ICP is labeled “Line ICP” in the figures). The ICP evaluations include one point cloud (e.g., from the one or more range sensors 104 of FIG. 1) for the time period t∈[−0.5, 0), and one point cloud for the time period t∈[0, 0.5), corresponding each to one distinct revolution of the range sensor with respect to the platform body frame. ICP is used to estimate the change in pose between these two point clouds. For comparison with the techniques described herein, the pose change is converted into velocities, such as linear and/or angular velocities (e.g., by the motion determination engine 122). This conversion can be performed using equation (10) in one illustrative example. The range sensor processing system 100 (e.g., the motion determination engine 122) can determine the value of t in equation (10) to optimize the solution. Observe that the pose change computed by ICP is over the time period that it takes for the range sensor to measure the same target twice. For ω=0, this is exactly ½ s in the above-noted setting. For non-zero ω, the time period instead has to be adjusted to 1/(2+ω/(2π)s. The ICP-estimated angular velocity can be used for this computation leading to a recursion, which can be solved by iterating it until convergence.

The techniques described herein can use a sparse basis expansion (e.g., a wavelet basis, such as a 2π-periodic Daubechies-2 (db2) wavelet with K=128 quantization points) and can impose a constraint on the basis coefficients (e.g., an explicit [symbol] ₁ constraint of 10 on the detail wavelet coefficients, e.g., on α₅, α₆, . . . , α_{K}). In some cases, the approximation wavelet coefficients α₁, α₂, α₂, α₄ are not constrained since they are the low-pass part of the signal and therefore can be expected to be nonzero. Estimates of ν and ω can be computed using the algebraic error minimization problem of equation (18), with the modifications for interpolation error and Huber loss as described herein.

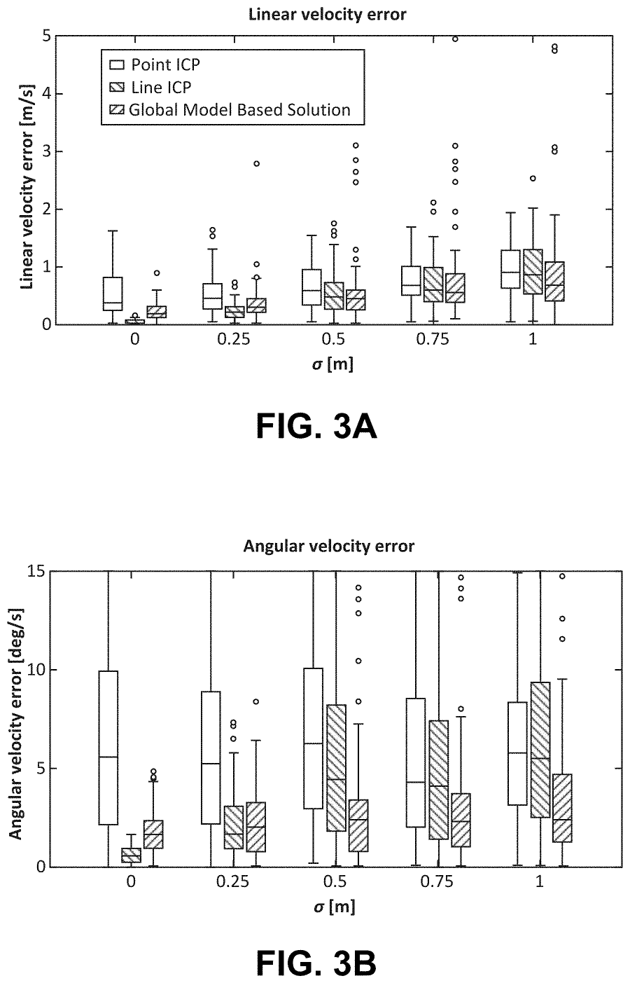

The impact of the measurement noise level governed by σ on the estimation performance can be explored by a comparison of the techniques disclosed herein with the two ICP approaches, as shown in FIG. 3A and FIG. 3B. For example, FIG. 3A and FIG. 3B illustrate the estimation error of ICP and the techniques described herein for the simulation scenario in FIG. 2A as a function of the measurement noise standard deviation. The platform velocities are v=(5, 0) m/s and ω=π/8 rad/s=22.5°/s. As shown in FIG. 3A and FIG. 3B, the techniques described herein yield better noise tolerance because of the global model, allowing it to more effectively average out the noise contributions. On the other hand, ICP fits only a local model, and is therefore more susceptible.

The number of range measurements N can have an impact on the estimation performance. The comparison of the techniques disclosed herein with the two ICP approaches is shown in FIG. 4A and FIG. 4B. For example, FIG. 4A and FIG. 4B illustrate the estimation error of ICP and the techniques described herein for the simulation scenario in FIG. 2A as a function of the number of measurements N. The platform velocities are v=(5, 0) m/s and ω=π/8 rad/s=22.5°/s. As shown in FIG. 4A and FIG. 4B, the global environment model of the global model based solution described herein can deal effectively with low measurement rates. Indeed, the performance of the global environment model performs well even with as few as N=60 measurements, while the local nature of ICP results in it needing more measurements for satisfactory performance.

The impact of angular velocity ω on the estimation performance can also be evaluated. In one example experiment analyzing the effect of motion distortion, it can be recalled that one point cloud is generated for each revolution of the range sensor. Since the revolutions are not instantaneous, the position of the platform changes within each revolution, leading to motion distortion of the measured point clouds.

For a platform with constant angular velocity and zero linear velocity in a 2-D setting, the motion distortion can be easily characterized. Indeed, the angular velocity co modifies the speed of revolution of the range sensor with respect to the environment. The majority of this effect is accounted for by the 1/(2+ω/(2π)) adjustment when going from the change in pose estimated by ICP to the velocity estimates as mentioned earlier. A second impact, noticeable mostly for larger values of |ω|, is that some targets are either seen twice or not at all in one of the point clouds.

The comparison of the global model based solution described herein with the two ICP approaches is shown in FIG. 5A and FIG. 5B. In particular, FIG. 5A and FIG. 5B illustrate the estimation error of ICP and the techniques described for the simulation scenario in FIG. 2A as a function of the angular velocity ω of the sensor. The linear velocity v is kept fixed at 0 m/s. As shown in FIG. 5A and FIG. 5B, the time adjustment is sufficient to remove the effects of motion distortion on ICP up to about ω=π/4 rad/s=45°/s. For larger angular velocities, the ICP performance starts to degrade. In cases when the global model based solution described herein does not make use of distinct point clouds, but rather processes each measurement with its exact timestamp, it is completely unaffected by motion distortion. As a result, it performs well even for large angular velocities.

Impact of linear body velocity v can also be explored. A nonzero value of ν leads again to motion distortion. As noted herein, for nonzero angular velocity, each target in the point cloud experienced the same distortion. The situation is more complicated for nonzero linear velocity. Here the amount of distortion is a function of the target range, where the smaller the range the larger the motion distortion.

The comparison of the techniques disclosed herein with the two ICP approaches is shown in FIG. 6A and FIG. 6B. In particular, FIG. 6A and FIG. 6B illustrate the estimation error of ICP and the techniques described for the simulation scenario in FIG. 2A as a function of the linear velocity ν=(ν₁, 0) of the sensor. The angular velocity co is kept fixed at 0 rad/s. As shown in FIG. 6A and FIG. 6B, even at a relatively low linear velocity of 10 m/s (corresponding to a platform motion of 5 m during the generation of each point cloud), the effect of motion distortion on the ICP performance is noticeable. In comparison, the global environment model based approach is again unaffected by motion distortion and performs better than ICP for large linear velocities.

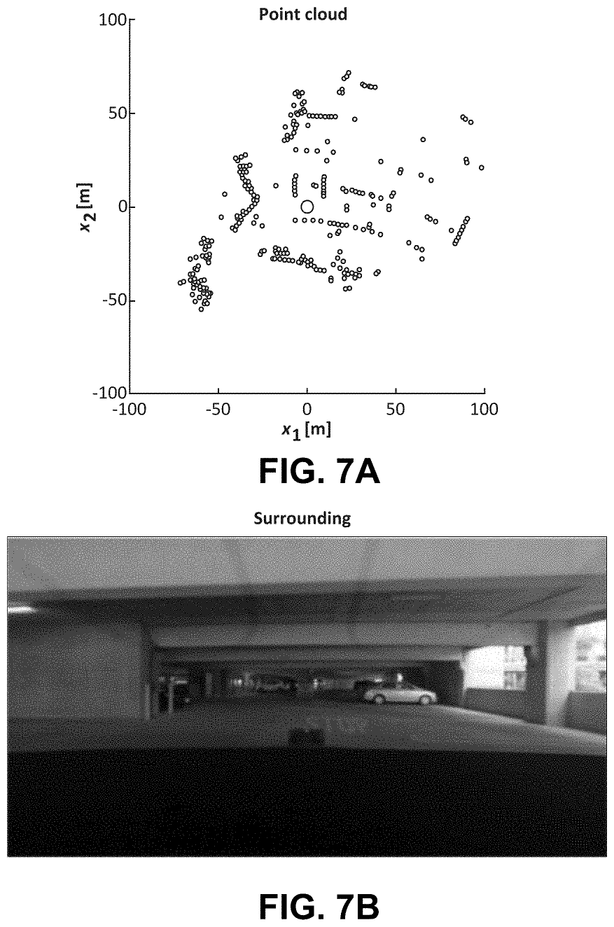

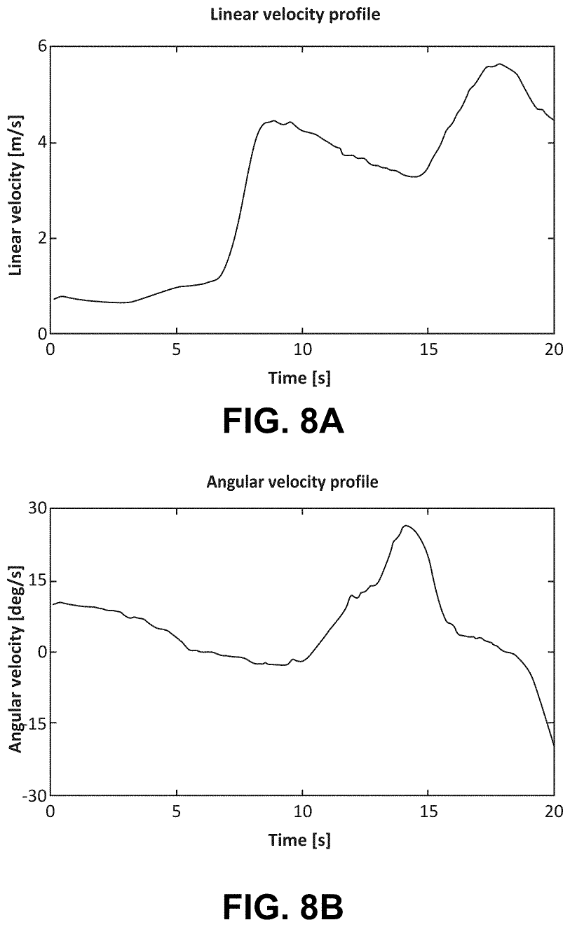

In one illustrative experiment, real or actual data was collected in a parking garage using a LIDAR mounted on the roof of a car. An example illustration of such an experiment is shown in FIG. 7A and FIG. 7B. In particular, FIG. 7A is a graph illustrating a sample point cloud for one LIDAR scan and FIG. 7B is a corresponding image for the parking garage example. The linear velocity of the vehicle varies in the range 0 m/s to 6 m/s and the angular velocity in the range −20°/s to 30°/s, as shown in FIG. 8A (illustrating the ground-truth linear velocity profile collected with the test vehicle) and FIG. 8B (illustrating the ground-truth angular velocity profile collected with the test vehicle). Data is collected from the horizontal laser on the LIDAR over a duration of 20 s, as the vehicle moves around the parking garage. The laser rotates about the vertical axis at a rate of 10 revolutions per second and measures the range to the nearest obstacle at an angular sampling interval of 0.2°.

To remove gross outliers, the data is preprocessed to use only range measurements less than 40 m and that have an intensity of at least 20% of the possible maximum. Ground-truth information is obtained from a survey-grade global navigation satellite system (GNSS) (e.g., global positioning system (GPS)) inertial navigation system. In all experiments below, the scan-matching algorithms are initialized with the ground-truth linear and angular velocities with added noise on the order of 0.5 m/s and 6°/s, respectively.

To evaluate the performance of the local and global approaches, two experiments were performed with this dataset. In the first experiment, synthetic Gaussian noise is added with standard deviation a varying in the range 0 m to 1 m. Note that the case σ=0 m corresponds to the unmodified sensor data. FIG. 9A and FIG. 9B illustrate the estimation error of ICP and the techniques described herein for the vehicular data collection with additional synthetic measurement noise as a function of the measurement noise standard deviation a. The results shown in FIG. 9A and FIG. 9B indicate that the global environment model approach described herein has better noise tolerance than the ICP approaches. This trend is in line with the observations from the synthetic data discussed previously (e.g., as shown in FIG. 3A and FIG. 3B).

In the second experiment, the collected range data is subsampled by a subsample factor from 1 to 16. Note that a factor of 1 corresponds to the unmodified sensor data. On the other extreme, a factor of 16 removes almost 15/16≈94% of the measurements. The results in FIG. 9A and FIG. 9B indicate that the global environment model approach described herein degrades more gracefully with decreased number of samples than the ICP approaches. This trend is again in line with the observations from the synthetic data presented earlier.

The systems and techniques described herein provide a solution to the problem of matching range scans to estimate the motion of a system (e.g., mobile robot, vehicle, etc.). The global environment model approach (e.g., performed by the system 100) described herein can use a versatile coefficient-based (e.g., wavelet-based or using other basis coefficients) model for either 3-D or 2-D environments. Careful modeling of the sensing process accounts for the effect of motion distortion on the measured range scans.

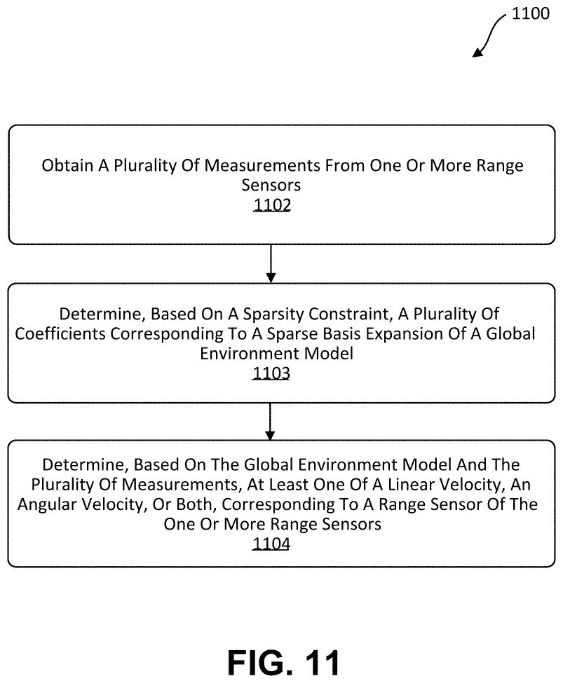

FIG. 11 is a flow diagram illustrating an example of a process 1100 for processing range sensor data. At operation 1102, the process includes obtaining a plurality of measurements from one or more range sensors. Examples of ranges sensors include light detection and ranging (LIDAR) sensor, a laser range finder, a radar, an ultrasonic sensor, an infrared (IR) sensor, or any combination thereof. In some aspects, measurements obtained from a range sensor can include an azimuth angle, an elevation angle, a range, or any combination thereof. For example, each measurement of the plurality of measurements can include at least one of an azimuth angle, an elevation angle, a range, or any combination thereof. In some cases, one or more of the measurements obtained from the range sensor can be associated with a timestamp.

At operation 1103, the process 1100 includes determining, based on a sparsity constraint, a plurality of coefficients corresponding to a sparse basis expansion of a global environment model. For instance, the basis expansion is sparse because it has sparse coefficients (e.g., most coefficients are zero), such as shown in FIG. 2B and FIG. 2C. The sparse basis expansion from equation (11) can be determined by imposing the sparsity constraint on the coefficients (e.g., the alpha vector). In one illustrative example, the sparsity constraint includes the ∥α∥₀≤| [symbol] | term from equation (13) and/or the ∥α∥₁≤| [symbol] | term from equation (16).

At operation 1104, the process 1100 includes determining, based on the global environment model, the plurality of coefficients, and the plurality of measurements, at least one of a linear velocity, an angular velocity, or both, corresponding to a range sensor of the one or more range sensors. The global environment model is based on the sparse basis expansion noted above. In one illustrative example, the sparse basis expansion can be represented using equation (11) provided above (e.g., as exp ( [symbol] αₖψₖ(θ))). In some aspects, the one or more range sensors can be mounted to a mobile object or system (e.g., robot, vehicle, etc.), and the linear velocity and/or angular velocity can correspond to the motion of the mobile object to which one or more range sensors are attached. In some cases, the one or more range sensors can be configured to rotate 360 degrees. In some aspects, the one or more range sensors may be or otherwise include solid-state devices. In other examples, one or more of the range sensors may be fixedly attached and directed to a particular direction.

In some cases, the process 1100 can include determining a range function based on the plurality of coefficients, as discussed above with respect to operation 1103. In some cases, the range function is a piecewise smooth function having a finite number of discontinuities. For instance, the range function can be represented using equation (11) provided above (e.g., ρ(θ, 0).) For instance, the left side of equation (11) (ρ(θ, 0)) can represent the range function and the right side of equation (11) (exp ( [symbol] αₖψₖ(θ))) can represent the sparse basis expansion of a global environment model. In some examples, the sparse basis expansion comprises a wavelet expansion and the plurality of coefficients comprise a plurality of wavelet coefficients. Other expansions and coefficients can be used in other examples, such as curvelet, contourlet, etc. For instance, in some aspects, the sparse basis expansion can include a wavelet expansion, a curvelet expansion, a contourlet expansion, any combination thereof, and/or other expansions. Similarly, the coefficients can include wavelet coefficients, curvelet coefficients, contourlet coefficients, any combination thereof, and/or other coefficients. In some cases, the plurality of coefficients includes at least one coefficient corresponding to at least one discontinuity in the range function (e.g., the discontinuities shown in FIG. 2B that correspond to one or more of the coefficients shown in FIG. 2C).

In some aspects, the plurality of measurements from the one or more range sensors can be used to identify one or more objects in a surrounding environment. In some cases, the plurality of measurements from the one or more range sensors can be used to generate indoor and/or outdoor maps of an environment. In some configurations, the one or more range sensors may be coupled to an apparatus that includes one or more wireless transceivers and may derive a location based on Global Navigation Satellite System (GNSS), Inertial Measurement Unit (IMU), LIDAR, Wireless Wide Area Network (WWAN), Wi-Fi, Bluetooth, Bluetooth Low Energy (BLE), any other suitable sensor/device, or any combination thereof. In other aspects, a range sensor may include one or more wireless transceivers and/or modems (e.g., a range sensor can have capability of performing mmWave communications).

In some examples, the measurements or data derived from the range sensors can be sent to one or more servers (e.g., edge server) for storage and/or additional processing. In some aspects, one or more servers can process data derived from the range sensors to create, develop, and/or enhance one or more maps (e.g., high definition (HD) maps). In some cases, an apparatus may transmit/receive measurements and/or data from the range sensors with another apparatus (e.g., to coordinate measurements). In one illustrative example, a vehicle with one or more range sensors may communicate with another vehicle to exchange data and/or measurements (e.g., using LTE-V2X).

In some examples, the processes described herein (e.g., process 1100 and/or other process described herein) may be performed by a computing device or apparatus. In one example, the process 1100 can be performed by a computing device with the computing system 1200 shown in FIG. 12. For example, processor 1210 can be communicatively coupled to one or more range sensors (e.g., using communications interface 1240) and processor 1210 can be configured to obtain a plurality of measurements from one or more range sensors. In some cases, processor 1210 can also be configured to determine, based on a global environment model, at least one of a linear velocity and an angular velocity corresponding to a range sensor, wherein the global environment model is based on a sparse basis expansion.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1100 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1100 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general-purpose processor and a hardware service or software service, such as services 1232, 1234, and 1236 stored in storage device 1230, configured to control processor 1210 as well as a special-purpose processor where software instructions are incorporated into the actual processor design. Processor 1210 can include one or more CPUs, ASICs, FPGAs, APs, GPUs, VPUs, NSPs, DPSs, microcontrollers, dedicated hardware, any combination thereof, and/or other processing device or system. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communications interface 1240 may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.12 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., light detection and ranging (LIDAR) sensors, laser range finders, radars, ultrasonic sensors, and infrared (IR) sensors) configured to collect data and provide measurements to processor 1210, whereby processor 1210 can be configured to perform determinations and calculations needed to obtain various measurements for the one or more range sensors. As discussed above, the measurements can include azimuth angle, elevation angle, a range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communications interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1: A method of processing range sensor data. The method comprises: obtaining a plurality of measurements from one or more range sensors; determining, based on a sparsity constraint, a plurality of coefficients corresponding to a sparse basis expansion of a global environment model; and determining, based on the global environment model, the plurality of coefficients, and the plurality of measurements, at least one of a linear velocity, an angular velocity, or both, corresponding to a range sensor of the one or more range sensors.

Aspect 2: The method of aspect 1, wherein the sparse basis expansion comprises a wavelet expansion and the plurality of coefficients comprise a plurality of wavelet coefficients.

Aspect 3: The method of any one of aspects 1 or 2, wherein the plurality of coefficients includes at least one coefficient corresponding to at least one discontinuity in the range function.

Aspect 4: The method of any one of aspects 1 to 3, further comprising: determining a range function based on the plurality of coefficients.

Aspect 5: The method of aspect 4, wherein the range function is a piecewise smooth function having a finite number of discontinuities.

Aspect 6: The method of any one of aspects 1 to 5, wherein the sparse basis expansion comprises at least one of a wavelet expansion, a curvelet expansion, a contourlet expansion, or any combination thereof

Aspect 7: The method of any one of aspects 1 to 6, wherein the one or more range sensors includes at least one of a light detection and ranging (LIDAR) sensor, a laser range finder, a radar, an ultrasonic sensor, an infrared (IR) sensor, or any combination thereof

Aspect 8: The method of any one of aspects 1 to 7, wherein the range sensor is mounted to a mobile object and is configured to rotate 360 degrees.

Aspect 9: The method of any one of aspects 1 to 8, wherein each measurement of the plurality of measurements includes at least one of a timestamp, an azimuth angle, an elevation angle, a range, or any combination thereof

Aspect 10: An apparatus for processing range sensor data. The apparatus comprises one or more range sensors; at least one memory; and at least one processor coupled to the at least one memory and configured to: obtain a plurality of measurements from one or more range sensors; determine, based on a sparsity constraint, a plurality of coefficients corresponding to a sparse basis expansion of a global environment model; and determine, based on the global environment model, the plurality of coefficients, and the plurality of measurements, at least one of a linear velocity, an angular velocity, or both, corresponding to a range sensor of the one or more range sensors.

Aspect 11: The apparatus of aspect 1, wherein the sparse basis expansion comprises a wavelet expansion and the plurality of coefficients comprise a plurality of wavelet coefficients.

Aspect 12: The apparatus of any one of aspects 1 or 2, wherein the plurality of coefficients includes at least one coefficient corresponding to at least one discontinuity in the range function.

Aspect 13: The apparatus of any one of aspects 1 to 3, further comprising: determining a range function based on the plurality of coefficients.

Aspect 14: The apparatus of aspect 13, wherein the range function is a piecewise smooth function having a finite number of discontinuities.

Aspect 15: The apparatus of any one of aspects 1 to 5, wherein the sparse basis expansion comprises at least one of a wavelet expansion, a curvelet expansion, a contourlet expansion, or any combination thereof

Aspect 16: The apparatus of any one of aspects 1 to 6, wherein the one or more range sensors includes at least one of a light detection and ranging (LIDAR) sensor, a laser range finder, a radar, an ultrasonic sensor, an infrared (IR) sensor, or any combination thereof

Aspect 17: The apparatus of any one of aspects 1 to 7, wherein the range sensor is mounted to a mobile object and is configured to rotate 360 degrees.

Aspect 18: The apparatus of any one of aspects 1 to 8, wherein each measurement of the plurality of measurements includes at least one of a timestamp, an azimuth angle, an elevation angle, a range, or any combination thereof

Aspect 19: The apparatus of any one of aspects 1 to 18, wherein the apparatus is part of a vehicle.

Aspect 20: The apparatus of any one of aspects 1 to 18, wherein the apparatus is part of a robot.

Aspect 21: The apparatus of any one of aspects 1 to 18, wherein the apparatus is part of an extended reality system.

Aspect 22: A computer-readable storage medium storing instructions that, when executed, cause one or more processors to perform operations according to any of aspects 1 to 9.

Aspect 23: An apparatus for processing range sensor data, the apparatus comprising means for performing operations according to any of aspects 1 to 10.

What is claimed is:

1. A method of processing range sensor data, the method comprising:
obtaining a plurality of measurements from one or more range sensors;
determining, based on a sparsity constraint, a plurality of coefficients corresponding to a sparse basis expansion of a global environment model; and
determining, based on the global environment model, the plurality of coefficients, and the plurality of measurements, at least one of a linear velocity, an angular velocity, or both, corresponding to a range sensor of the one or more range sensors.

2. The method of claim 1, wherein the sparse basis expansion comprises a wavelet expansion and the plurality of coefficients comprise a plurality of wavelet coefficients.

3. The method of claim 1, further comprising:
determining a range function based on the plurality of coefficients.

4. The method of claim 3, wherein the range function is a piecewise smooth function having a finite number of discontinuities.

5. The method of claim 3, wherein the plurality of coefficients includes at least one coefficient corresponding to at least one discontinuity in the range function.

6. The method of claim 1, wherein the sparse basis expansion comprises at least one of a wavelet expansion, a curvelet expansion, a contourlet expansion, or any combination thereof

7. The method of claim 1, wherein the one or more range sensors includes at least one of a light detection and ranging (LIDAR) sensor, a laser range finder, a radar, an ultrasonic sensor, an infrared (IR) sensor, or any combination thereof

8. The method of claim 1, wherein the range sensor is mounted to a mobile object and is configured to rotate 360 degrees.

9. The method of claim 1, wherein each measurement of the plurality of measurements includes at least one of an azimuth angle, an elevation angle, a range, or any combination thereof.

10. An apparatus for processing range sensor data, comprising:
one or more range sensors;
at least one memory; and
at least one processor coupled to the at least one memory and configured to:
obtain a plurality of measurements from a range sensor of the one or more range sensors;
determine, based on a sparsity constraint, a plurality of coefficients corresponding to a sparse basis expansion of a global environment model; and
determine, based on the global environment model, the plurality of coefficients, and the plurality of measurements, at least one of a linear velocity, an angular velocity, or both, corresponding to a range sensor of the one or more range sensors.

11. The apparatus of claim 10, wherein the sparse basis expansion comprises a wavelet expansion and the plurality of coefficients comprise a plurality of wavelet coefficients.

12. The apparatus of claim 10, wherein the at least one processor is further configured to:
determine a range function based on the plurality of coefficients.

13. The apparatus of claim 12, wherein the range function is a piecewise smooth function having a finite number of discontinuities.

14. The apparatus of claim 12, wherein the plurality of coefficients includes at least one coefficient corresponding to at least one discontinuity in the range function.

15. The apparatus of claim 10, wherein the sparse basis expansion comprises at least one of a wavelet expansion, a curvelet expansion, a contourlet expansion, or any combination thereof

16. The apparatus of claim 10, wherein the one or more range sensors includes at least one of a light detection and ranging (LIDAR) sensor, a laser range finder, a radar, an ultrasonic sensor, an infrared (IR) sensor, or any combination thereof.

17. The apparatus of claim 10, wherein the range sensor is mounted to a mobile object and is configured to rotate 360 degrees.

18. The apparatus of claim 10, wherein each measurement of the plurality of measurements includes at least one of an azimuth angle, an elevation angle, a range, or any combination thereof

19. The apparatus of claim 10, wherein the apparatus is part of a vehicle.

20. The apparatus of claim 10, wherein the apparatus is part of a robot.

21. The apparatus of claim 10, wherein the apparatus is part of an extended reality system.

22. A computer-readable medium comprising at least one instruction for causing a computer or processor to:
obtain a plurality of measurements from a range sensor of one or more range sensors;
determine, based on a sparsity constraint, a plurality of coefficients corresponding to a sparse basis expansion of a global environment model; and
determine, based on the global environment model, the plurality of coefficients, and the plurality of measurements, at least one of a linear velocity, an angular velocity, or both, corresponding to a range sensor of the one or more range sensors.

23. The computer-readable medium of claim 22, wherein the sparse basis expansion comprises a wavelet expansion and the plurality of coefficients comprise a plurality of wavelet coefficients.

24. The computer-readable medium of claim 22, further comprising at least one instruction for causing the computer or the processor to:
determine a range function based on the plurality of coefficients.

25. The computer-readable medium of claim 24, wherein the range function is a piecewise smooth function having a finite number of discontinuities.

26. The computer-readable medium of claim 24, wherein the plurality of coefficients includes at least one coefficient corresponding to at least one discontinuity in the range function.

27. The computer-readable medium of claim 22, wherein the sparse basis expansion comprises at least one of a wavelet expansion, a curvelet expansion, a contourlet expansion, or any combination thereof

28. The computer-readable medium of claim 22, wherein the one or more range sensors includes at least one of a light detection and ranging (LIDAR) sensor, a laser range finder, a radar, an ultrasonic sensor, an infrared (IR) sensor, or any combination thereof

29. The computer-readable medium of claim 22, wherein the range sensor is mounted to a mobile object and is configured to rotate 360 degrees.

30. The computer-readable medium of claim 22, wherein each measurement of the plurality of measurements includes at least one of an azimuth angle, an elevation angle, a range, or any combination thereof.
